(19) United States
(12) Patent Application Publication
(10) Pub. No.: US 2011/0123793 A1
(43) Pub. Date: May 26, 2011

(54) ARTICLE FOR INSULATION AND METHOD FOR PRODUCTION THEREOF

(76) Inventor: Walter Tasser, Pfalzen (BZ) (IT)

(21) Appl. No.: 12/991,441

(22) PCT Filed: May 8, 2009
(86) PCT No.: PCT/IB09/51917

§ 371 Date: Feb. 1, 2011

Related U.S. Application Data
(60) Provisional application No. 61/097,609, filed on Sep. 17, 2008.

(30) Foreign Application Priority Data
May 9, 2008 (IT) RM2008A000251

(51) Int. Cl. E04B 1/74; B32B 5/02; B29C 45/14; E04B 1/82

(52) U.S. Cl. 428/221; 252/62; 264/257; 181/284

(57) ABSTRACT

An article for insulation (1, 101) for use in the building sector or for constructions, comprising wool (2, 3) and a stiffening material, specifically magnesium hydroxide (9), distributed within the wool (2, 3). Specifically, said article for insulation is panel-shaped (1, 101). Preferably, said wool (2, 3) is sheep wool. A method for production of an article for insulation (1, 101) for use in the building sector or for constructions, wherein said article for insulation (1, 101) is obtained by combination of wool (2,3) and a stiffening material, specifically magnesium hydroxide (8, 9).

The present disclosure refers to an article for insulation in the building sector or for construction, such as for instance a panel, and a method for the production thereof. Specifically the present disclosure refers to an article for both thermal and acoustic insulation, which hence can be used as a thermal insulator and/or an acoustic insulator.

The houses and the buildings in general often require that the walls are provided with suitable layers of heat-insulating material, so as to reduce the heat exchanges due to conduction between the interior and the exterior and to limit the need for heating and/or cooling of the interior.

To this, it can also be added the need for providing an acoustic insulation of an interior with respect to the exterior or to other interiors originating an unwanted noise.

Similar requirements are found not only in the building sector, but also in the construction sector in general, for example in the insulation of a passenger compartment of a vehicle, specifically of a railroad car.

The described requirements are usually met by using insulation panels, which can be applied to the surface of a wall and/or be inserted in a cavity of the wall itself. The employed panels have usually the property of having a low thermal conductivity (so-called heat-insulating panels) and/or high sound-absorption capacity (so-called sound-absorbent panels).

For this purpose, panels made out of plastic or synthetic material derived from petrochemical industry, such as polystyrene, polyurethane, polyethylene, polycarbonate, or rock wool or glass wool, are widely used. The production of these types of panels entails a high energy input (if the entire production and product life cycle is considered) and the use of not-renewable raw material.

Since the employed synthetic materials are flammable and moreover they generate toxic compounds during the combustion, fire inhibitor compounds or fire retardants have to be added to them; this results in higher production costs and safety issues related to using potentially noxious chemicals.

In addition, an appropriate disposal of the panels once they reach the end of their useful life is problematic, because the employed synthetic materials are not biodegradable.

In addition it should be considered that these known-art panels are not suitable to be used in the green building sector, because they are made out of non-natural materials.

Panels made out of wood fibers are also available on the market, but they can only partially overcome some of the disadvantages mentioned above. However, these panels have disadvantages in terms of fire resistance, resistance to parasites and biological decay, because the employed materials on their own do not have these characteristics. Moreover these panels, in some typologies of products, have often disadvantages in terms of how they are applied, installed and maintained, because they often do not have a rigid structure, but they are rather flexible, similar to “carpets”.

The present disclosure moves from the technical problem of providing an article for insulation, for example a panel, in particular for use in the building sector or for constructions in general, and a method for production thereof, which can overcome the disadvantages mentioned above with reference to known art.

This is achieved by providing an article for insulation for use in the building sector or for constructions as defined in the independent claim 1 and a method for producing an article for insulation for use in the building sector or for construction as defined in the independent claim 11.

Secondary features of the subject of the present disclosure are defined in the corresponding dependent claims.

In the preferred embodiment, the stiffening material is magnesium hydroxide or so-called slaked lime.

The subject of the present disclosure provides a number of significant advantages. The main advantage lies in the fact, that the article and the relative method according to the present disclosure allow to use natural materials, which are suitable for use in the green building sector. Moreover, such materials cause smaller problems considering the disposal of the article for insulation at the end of its use. Specifically, the article for insulation according to the present disclosure couples the insulation properties of wool with the physical properties, as for instance rigidity, which result from the combination with the stiffening material, which specifically in a preferred embodiment is the solution of magnesium hydroxide or so-called slaked lime, which is a natural stabilizer. Consequently, insulating articles are obtained, as for instance, in a preferred embodiment, panels, which are substantially rigid and ready to be directly installed on a wall. The article can be manufactured in a continuous process as a large piece and can be cut and shaped according to the installation needs. For instance, in a preferred embodiment, the article is a slab produced as a single piece, from which panels of proper size are cut.

Thanks to the hygroscopic properties of the wool, the article according to the present disclosure is suitable to be applied also in rooms, where a humidity control is required; in fact the wool can absorb and release humidity (up to 40% of it's own weight) without any degradation or significant loss of it's thermal insulation properties.

In addition, wool can absorb large amounts of formaldehyde, which is a pollutant often present in buildings, and other air contaminants: in this way the panels according to the present disclosure contribute to the improvement of the air quality of the room where they are installed.

Another advantage lies in the fact, that the method allows to obtain articles for insulation which are fire resistant and have no problems with parasites, fungi or biological decay, due to the disinfecting and antiseptic action of the lime (slaked lime).

Another advantage lies in the fact, that the article according to the present disclosure, preferably in the form of a panel, can be easily attached to a wall and it has a very good resistance to deformations and bending.

Another advantage more lies in the fact, that the method is simple and inexpensive, because it uses easily-available materials, and it entails by far less energy input than known-art processes. As an example, in an embodiment, the employed wool is sheep wool, which often is considered a waste of farming for meat production, because its quality is inadequate for use in the textile sector. Consequently, sheep wool is easily available at a low cost, or even at zero cost, and the use of a material, which otherwise would be unexploited, is favorably enabled.

Further advantages, features, and the operation modes of the subject of the present disclosure will be made evident in the following detailed description of a preferred embodiment thereof, given by way of example and not for limitative purposes.

However, it is evident that each embodiment of the subject of the present disclosure can have one or more of the advantages listed above; in any case, it is not required for every embodiment to have all the listed advantages at the same time.

Reference will be made to the figures of the annexed drawings, wherein:

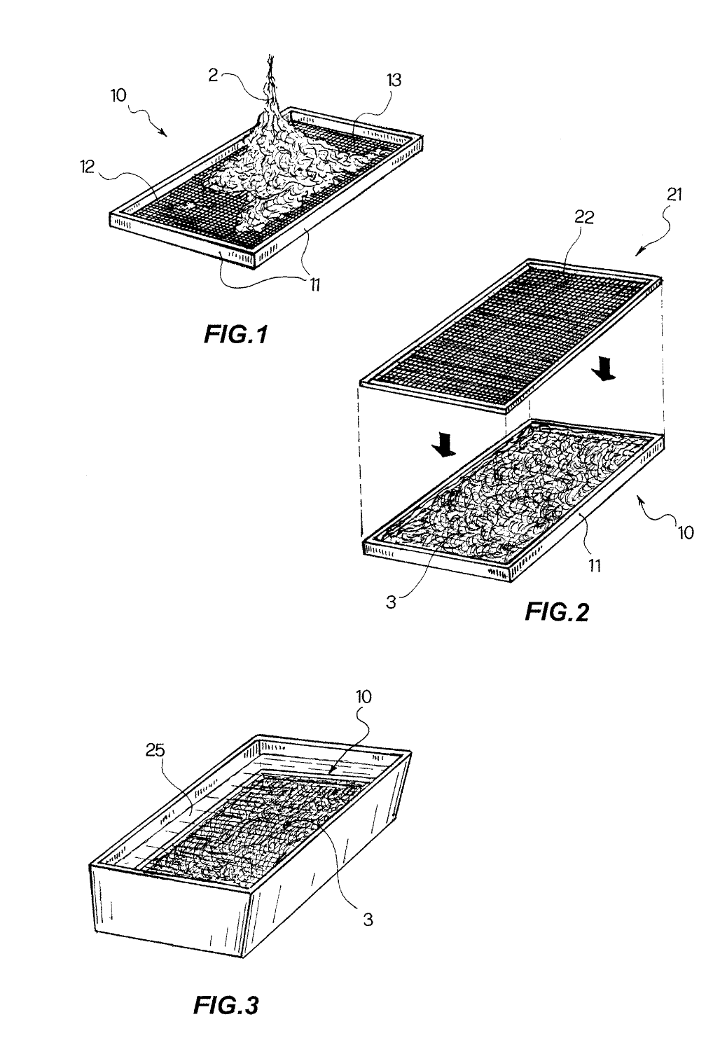

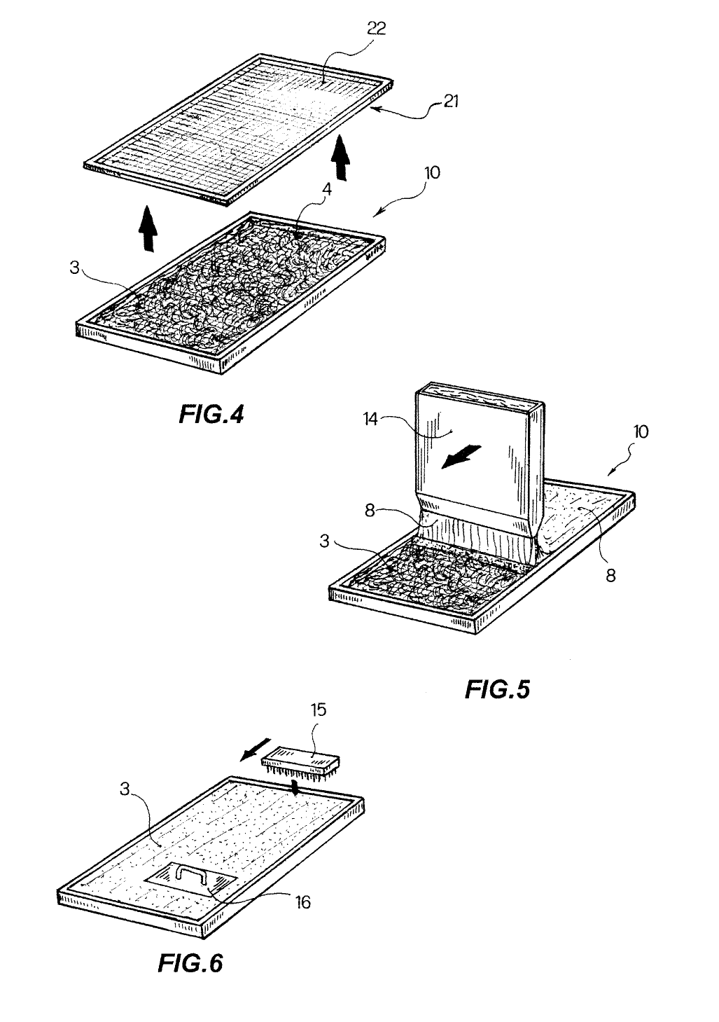

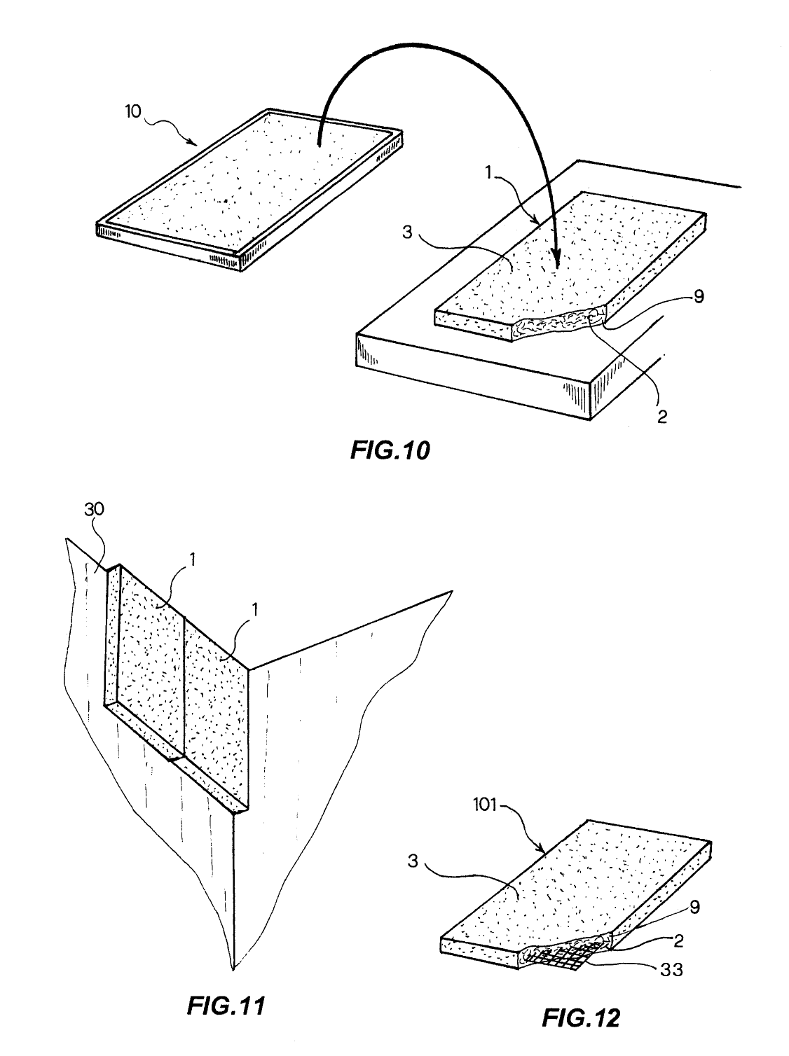

FIGS. 1 through 10 show in sequence the steps of the method according to the present disclosure;

FIG. 11 shows articles for insulation according to the present disclosure, which are attached to a wall;

FIG. 12 shows a partially-sectional view of a second embodiment of an article for insulation according to the present disclosure.

First of all, the production method according to the present disclosure provides for providing a containment frame 10, or containment structure, which is provided with side walls 11 which delimit a support surface 12 or bottom surface. The support surface 12 and the side walls 11 define a volume, wherein the production of an article for insulation, which in the example is in the shape of a panel 1, takes place. This panel 1, which is a subject of the present disclosure as well, is specifically suitable for a use in the building sector or for constructions in general, such as passenger compartments of vehicles, as for instance of a railroad car. Thus the dimensions and the shape of said volume of the frame 10 are in any case related to the dimensions and shape of the panel 1 which is to be obtained, and specifically the dimensions of the support surface 12 are substantially equivalent to the dimensions of the plan view of said panel 1. In the annexed figures a frame 10 is shown, which has a substantially parallelepiped-like shape, but it is intended that the shape of the frame itself can be different, for example cylinder-like or prism-like.

The support surface 12 preferably comprises at least one perforated portion and, in the preferred embodiment, it comprises a grid 13. In addition the support surface 12 can be associated or is associable to the containment frame 10 in a removable manner; in fact it can be separated from said side walls 11.

As shown in FIG. 1, an amount of wool 2 is arranged in the containment frame 10, so that it forms a layer 3, which substantially covers the support surface 12 delimited by the side walls 11. Preferably, the employed wool 2 is sheep wool.

In alternative embodiments, wool from other animals or mineral wool or other materials having heat-insulation properties equivalent to wool (for example cotton), or a combination of these, is used.

Prior to arranging the wool in the containment frame 10, a step of cutting said amount of wool 2, which allows to make it in pieces having a size of about 2 or 3 cm, can be required.

Moreover, a washing step of the amount of wool 2, preferably using warm water at a temperature between 30° C. and 50° C., might be necessary. The washing step is done prior to arranging the wool 2 in the frame 10 and/or when the wool 2 has already been arranged in the frame 10. In this second case, as shown in FIG. 2 through 4, the washing can be done by arranging a grid 22 (or a second frame 21 similar to said containment frame 10) on the layer 3 of wool 2 and by fastening it to the frame 10 with suitable fastening means, so that layer 3 be enclosed between the support surface 12 and this grid 22; at this point, the so-obtained assembly can be immersed into a water bath 25 for doing the washing, or be subjected to a water jet directed for example on the grid 22. The grid 22 (or the second frame 21) is then removed.

At this point the production method provides for adding an amount of a stiffening material, for example an aqueous solution 8 of magnesium hydroxide or slaked lime (therefore a solution including stiffening material), to the layer 3 of wool 2 (FIG. 5), in such a way that said solution 8 of magnesium hydroxide is distributed in a substantially homogenous manner within the layer 3.

The layer 3 essentially facilitates a homogenous distribution of magnesium hydroxide 9 within the wool 2; within the layer 3 a combination of wool 2 and magnesium hydroxide 9 is therefore got.

For instance, this is accomplished by pouring the aqueous solution 8 of magnesium hydroxide onto a first side 4 of the layer 3, specifically onto the side 4 opposed, i.e. not adjacent, to the support surface 12. For this purpose a suitable dispenser 14 is used. Moreover, the solution 8 is to be distributed as evenly as possible. A greater evenness can be achieved by working and smoothing the layer 3 by means of a board 15 with nails and/or a spatula 16 or a similar tool (FIG. 6).

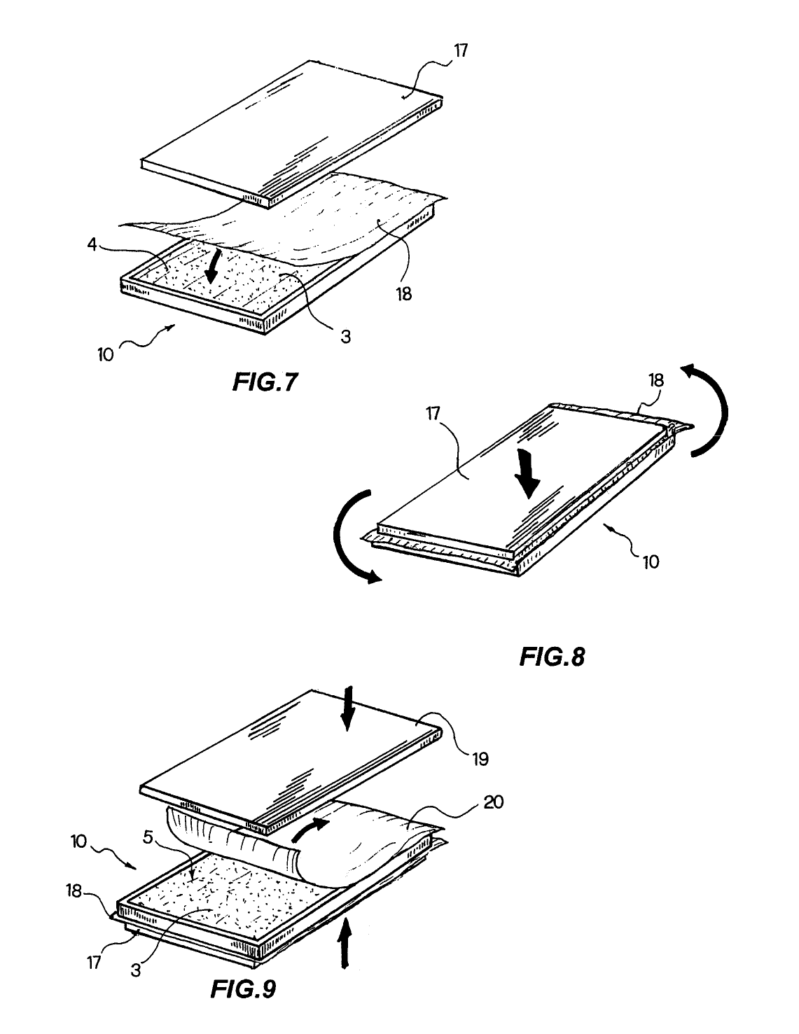

As shown in FIGS. 7 and 8, a rigid and substantially flat element 17 (for example a board or a plate) is placed on said first side 4 and is associated to the frame 10 with suitable fastening means (for example, by using metal rods, which are inserted in appropriate holes in the frame 10, specifically in the side walls 11) so that it cannot be accidentally disconnected from the frame 10. In case, it is possible to position a sheet 18, made out of plastic material or similar material, between the rigid element 17 and the first side 4 of the layer 3.

At this point the frame 10 is turned 180 degrees so that the first side 4 is facing down and the operator has access to the support surface 12. After removing said support surface 12, if necessary, an amount of solution 8 of magnesium hydroxide is distributed also on a second side 5 of the layer 3, i.e. on the side 5 which is opposed to the first side 4 and is adjacent to the support surface 12 itself, in similar fashion to the one described above.

Also here, the homogeneity of the distribution of the solution 8 within the layer 3 can be increased by using said board 15 with nails and/or said spatula 16. As described for the first side 4, a rigid and substantially flat element 19 (board, plate or similar) is placed on the second side 5 and is fastened to the frame 10 to prevent it from being accidentally disconnected from the frame 10; a sheet 20 made out of plastic material can be positioned between said rigid element 19 and the second side 5 (FIG. 9).

In addition to the above-described modes, other modes for distributing the aqueous solution 8 of magnesium hydroxide into the layer 3 of wool 2 are possible. The wool 2 and the aqueous solution 8 of magnesium hydroxide could also be combined and mixed each other prior to arranging the wool 2 in the containment frame 10.

Moreover, it is possible to provide for arranging a reinforcement 33 within said layer 3, in order to enhance the mechanical properties of the obtained panel. This reinforcement, which is preferably made out of metal, for example is a netting or a metal grid 33, is placed parallel to the support surface 12 during the step of arranging the wool 2 in the frame 10, so that said reinforcement 33 is inserted within the layer 3.

The next step of the method provides for exerting a pressing action on the layer 3 in a direction substantially perpendicular to the layer 3 itself, so that the layer 3 is compacted and pressed, so facilitating the separation of water absorbed by it. For instance, this can be accomplished using a press or a centrifuge.

At the end of the steps described above, the layer 3 is enclosed between two rigid elements 17 and 19, which have surfaces adapted to exert a pressing action on the layer 3 in a substantially uniform fashion, for example by means of a press. The pressing action can obviously be exerted also using means other than a press, for example by placing a body with a proper mass on the rigid element facing up, or it can be manually exerted.

If a sheet 18 and/or 20 of plastic material has been positioned between at least one of the rigid elements 17 and/or 19 and the layer 3 before exerting the pressing action, then a better flowing of water coming out of the frame, a lower dirtying of the relative rigid element 17 or 19, and a corresponding smoother surface of the layer 3 are achieved.

Said pressing action can be exerted in a substantially identical fashion also when a rigid element 17 or 19 has been placed at only one side of the layer 3, while the second side has been left directly adjacent to said support surface 12.

Thereafter, the production method provides for drying the solution 8 of magnesium hydroxide within the layer 3. This can be accomplished in a natural fashion in the open air, or in a drying chamber at an adjustable temperature and humidity.

This way a panel 1 is obtained, which can be removed from the containment frame 10 prior or after said drying step, depending on the process requirements.

In case that a panel 1 with rigid framework is to be obtained, said framework can be constituted by said side walls 11; in this case the panel 1 is made in such a way that it cannot be removed from the containment frame 10, which in fact constitutes the supporting structure thereof even after final installation.

Depending on the characteristics of the panel 1 to be obtained, the amount of aqueous solution 8 of magnesium hydroxide to be added to the layer of wool 2 is approximately comprised between 4 and 7 liters per each kilogram of wool 2, with a concentration such as to provide an amount of magnesium hydroxide 9 comprised between 4 and 12 grams per each kilogram of wool 2.

In alternative embodiments, the aqueous solution 8 of magnesium hydroxide is replaced by another alkaline solution, for example a solution of magnesium hydroxide Mg(OH)₂ or an alkaline solution recycled from water treatment processes, or an alkaline mixture. For example, in an embodiment the aqueous solution 8 contains magnesium hydroxide and magnesium hydroxide, in a ratio depending on the specific requirements.

The described method provides an article for insulation, as the above-mentioned panel 1 for use in buildings or for construction in general, which comprises wool 2 and magnesium hydroxide 9 (i.e., said stiffening material), which specifically comes from said aqueous solution 8 and is distributed within the wool 2. In the example, the panel 1 comprises a layer 3 of wool 2, in which magnesium hydroxide 9 is distributed in a substantially homogenous fashion, in an amount comprised between 4 and 12 grams per each kilogram of wool 2.

The panel 1 is hard and stiff, but it has still a certain degree of flexibility. In other words, in contrast to the starting material, which is loose and soft wool, the panel 1 has a stiffness which can be controlled by setting the amount of aqueous solution 8 of magnesium hydroxide or slaked lime to be used. This allows to obtain a panel 1, which is ready for installation directly on the surface to be insulated.

The stiffness associated to a certain flexibility is particularly advantageous and, for instance, allows the use of the panel 1 for seismic support, i.e., for providing a structural support during an earthquake. In other words, when the panel 1 is installed and mounted onto a wall, which for example is made of bricks or with wood frame, the fibrous structure of the panel 1 increases the structural resistance of the wall itself to the shear stresses and the tensile stresses, which specifically occur during an earthquake. In fact the panel 1 increases the breaking load of the wall, rigidifying it against a bending or a bulging on the side of the wall where the panel 1 is installed.

Duly selecting the thickness of the layer 3 and/or the amount of magnesium hydroxide 9 (slaked lime) per unit weight of wool, it is also possible to obtain a panel 1, which is flexible and for example is suitable to be wrapped around a tube or inserted into a tube.

In a preferred embodiment, said wool is sheep wool.

For example, the panel 1 can have a parallelepiped-like shape with plan-view dimensions of 50 cm×50 cm, or 50 cm×70 cm, or 4 ft×8 ft, and for example a thickness of 2.5 cm or 1 in, or a thickness of 7.5 cm or 3 in, or even thicker. In general, when using an appropriate frame 10, the panel 1 can be made with the required dimensions, thickness and shapes, which depend on the specific application for which the panel 1 is intended.

In an embodiment shown in FIG. 12, an article for insulation 101 according to the present disclosure, which for example is a panel, comprises a reinforcement 33 inserted within said layer 3. Such an embodiment can be particularly advantageous, when the article for insulation 101 is intended to be used for seismic support.

The panels 1, 101 can be used for thermal or acoustic insulation of a room delimited by at least one wall 30, in which the panels 1, 101 are included. For example, the panels 1, 101 can be easily fastened on the wall 30 by means of glue, cement, lime, screws, nails, bolts or other known-art fastening means. In the example, the panels 1 are applied to the wall 30 next to each other, in order to cover the whole surface of interest.

Next, the panels 1 and the gaps between them are filled with putty and the surface is painted. In order to fasten together a number of panels 1 and/or to make the surface smoother and homogenous, after mounting the panels 1 on the wall 30, a netting can be positioned on the surfaces at sight of the panels 1, prior to proceeding with puttying and painting.

With particular reference to the panel 1, 101 made with sheep wool, it was found that it has good insulation properties, because in fact it has a thermal conductivity of the order of 0.05÷0.06 W/(m·K) and a specific heat capacity of the order of 0.9÷1.0 kJ/(kg·K) for a panel 1, 101 dried at 100° C. Moreover it has a fire resistance corresponding to Euroclass E, or comprised between Euroclasses B and E; the fire resistance depends on the production modes and specifically depends on the ratio between the amount of wool and the amount of magnesium hydroxide comprised in the panel 1, and in addition depends on fire-retardant compounds that can be used and added according to the needs.

Therefore, the panel 1, 101 not only is made of fully natural and environmentally sustainable material, but it also has high values of thermal insulation and heat capacity, in addition to fire resistance.

Therefore, the mechanical and insulation properties of the panel 1, 101 allow its direct use for the coating of walls 30, both for new buildings and for renovation of existing buildings.

The wool, moreover, is able to absorb and release humidity without causing a degradation or a significant loss of its thermal insulation properties.

So the panel 1, 101 can replace, with one product, both a known-art insulating panel and a dehumidifier layer of “dry wall” type.

The presence of magnesium hydroxide 9, in addition to increasing the fire resistance of the wool and to stiffening the panel, makes also sure that the panel 1, 101 has a high resistance to mould, parasites and fungi; in fact the high pH (for example equal to 11 or higher), which is due to the presence of magnesium hydroxide 9, inhibits the survival of microorganisms within the wool and then makes the fibers of the same inert. The panel 1, 101 can be directly installed on existing walls: in fact experimental tests have proved, that it is able to reduce the existing mould thanks to its high pH.

The panel 1, 101 subject of the present disclosure is produced using natural and biocompatible materials and then it can be used also in the sustainable and green building sector. In fact it is an excellent eco-friendly alternative for products made from glass wool, rock wool, polystyrene foam or polymeric plastics, which inter alia require a higher energy input during their production and their disposal.

In addition to the use in the building sector, the panel 1, 101 can also be used in the construction sector in general and in other sectors whenever a wall or an environment has to be insulated. As an example, the panel 1, 101 can be used in a railway car and be applied to the walls of the car in order to increase the thermal and/or acoustic insulation of a passenger compartment with respect to the exterior environment.

The method according to the present disclosure also allows to economically use and to add value to quantities of sheep wool which often do not have a market outlet.

The above-described production method can be used both on a crafts-men level and on an industrial scale. For the second case, the various production steps here described can be done in a series along a production line, in case in an automated manner. For example, a plurality of frames 10 or other containment structures can be associated to a conveyor belt, along which the production steps take place.

Some steps, for example the step of adding and distributing the solution 8 of magnesium hydroxide, or the washing step, or the pressing step, or the drying step, can be operatively accomplished on an industrial scale in a mode which is different from the modes described above in details, even though it will achieve the same technical result. It is presumed that the transposition of the previously described production steps to an industrial scale is within the ability of the person skilled in the art, in the light of the description above, and then said steps on an industrial scale are not described here in detail.

The subject of the present disclosure has been described hereto with reference to preferred embodiments thereof. It is understood, that other embodiments, which are related to the same inventive core, might exist, all included within the scope of protection of the claims hereinafter.

1. An article for insulation (1, 101) for use in the building sector or for constructions, comprising wool (2, 3) and a stiffening material distributed within the wool (2, 3).

2. The article for insulation (1, 101) according to claim 1, wherein said article for insulation is panel-shaped (1, 101).

3. The article for insulation (1, 101) according to claim 1 or 2, wherein said stiffening material is calcium hydroxide (9).

4. The article for insulation (1, 101) according to any one of the preceding claims, comprising a layer (3) of wool (2), in which calcium hydroxide (9) is distributed.

5. The article for insulation (1, 101) according to any one of the preceding claims, wherein said wool (2) is sheep wool.

6. The article for insulation (1, 101) according to claim 4 or 5, wherein said layer (3) comprises calcium hydroxide (9) in an amount comprised between 4 and 12 grams per each kilogram of said wool (2).

7. The article for insulation (1, 101) according to any one of the preceding claims, further comprising a reinforcement (33) associated to the wool (2,3).

8. The article for insulation (1, 101) according to claim 7 when dependent on claim 4, wherein said reinforcement (33) is inserted within said layer (30).

9. A use of an article for insulation (1, 101) according to any one of claims 1 to 8 for thermal insulation or for acoustic insulation of a room delimited by at least one wall (30), wherein said article for insulation (1, 101) is included in said wall (30).

10. A use of an article for insulation (1, 101) according to any one of claims 1 to 8 for increasing the structural resistance of a wall (30), wherein said article for insulation (1, 101) is included in said wall (30).

11. A method for producing an article for insulation (1, 101) for use in the building sector or for constructions, wherein said article for insulation (1, 101) is obtained by combination of wool (2, 3) and a stiffening material (9).

12. The method according to claim 11, wherein a solution (8) including stiffening material (9) is distributed into the wool (2, 3).

13. The method according to claim 11 or 12, comprising the steps of
(a) providing a containment frame (10) provided with side walls (11) which delimit a support surface (12);
(b) arranging in said containment frame (10) an amount of wool (2) so that it forms a layer (3) which substantially covers said support surface (12);
(c) adding an amount of solution (8) including stiffening material to said layer (3) of wool (2), so that said solution (8) including stiffening material is distributed within said layer (3);
(d) exerting a pressing action on said layer (3) in a direction substantially perpendicular to said layer (3).

14. The method according to claim 13, comprising the step of placing a reinforcement (33) parallel to said support surface (12), so that said reinforcement (33) be inserted within said layer (3) of wool (2).

15. The method according to claim 13 or 14, wherein said step (d) is accomplished by means of a press.

16. The method according to any one of claims 13 to 15, wherein said step (d) is accomplished by enclosing said layer (3) between two rigid elements (17, 19) having surfaces adapted to exert said pressing action in a substantially uniform fashion on said layer (3).

17. The method according to claim 16, comprising the step of arranging a sheet (18, 20) in plastic material between at least one of said rigid elements (17, 19) and said layer (3) prior to exerting said pressing action.

18. The method according to any one of claims 13 to 17, comprising the step of removing said article for insulation (1, 101) from said containment frame (10) after said step (d).

19. The method according any one of claims 13 to 18, comprising the step of drying said amount of solution (8) including stiffening material within said layer (3) after said step (d).

20. The method according to any one of claims 13 to 19, wherein said step (b) or said step (c) is preceded by the step of washing said amount of wool (2) using water (25) at a temperature between 30 ° C. and 50 ° C.

21. The method according to any one of claims 13 to 20, wherein said support surface (12) comprises at least one perforated portion.

22. The method according to claim 21, wherein said support surface (12) comprises a grid (13).

23. The method according to any one of claims 13 to 22, wherein said support surface (12) is associated or associable to said containment frame (10) in a removable manner.

24. The method according to any one of claims 11 to 23, wherein said stiffening material is calcium hydroxide (8, 9)

25. The method according to any one of claims 13 to 23, wherein said stiffening material is calcium hydroxide (9), said solution (8) including stiffening material is an aqueous solution (8) of calcium hydroxide (9), and said amount of aqueous solution (8) of calcium hydroxide is such as to provide an amount of calcium hydroxide (9) comprised between 4 and 12 grams per each kilogram of said amount of wool (2).
